(19) United States
(12) Patent Application Publication
(10) Pub. No.: US 2004/0098465 A1
(43) Pub. Date: May 20, 2004

(54) Method and system for sharing data over internet

(76) Inventor: Young Hyun Seo, Daegu (KR)

Correspondence Address: BIRCH STEWART KOLASCH & BIRCH, PO BOX 747, FALLS CHURCH, VA, 22040-0747, US

(21) Appl. No.: 10/471,258

(22) PCT Filed: Mar. 21, 2002
(86) PCT No.: PCT/KR02/00478

(30) Foreign Application Priority Data
Mar. 27, 2001 (KR) 2001/15893

(51) Int. Cl. G06F 15/16

(52) U.S. Cl. 709/217

(57) ABSTRACT

This invention is about the method and system for sharing data over internet, which activates data upload and sharing data by letting the information users to pay information fee to the information provider if he judges the data us useful when he uses the upload data in the data sharing site. And in case of the data is not useful and of no value for sharing, it will not be used and naturally selected out, and this will reduce the circulation and distribution of such harmful data.

### TECHNICAL FIELD

This invention is about the method and system for sharing data over internet which enables to share data (information) of high quality informations and to contribute to the activation of sharing information by having the information provider to serve more advanced quality-information when they open it to unspecified multiple persons on internet and by paying a certain amount of price for sharing data to the information provider.

### BACKGROUND ART

Development of technology rapidly promotes the supply of internet. Internet industry is explosively developed these days and a large number of host computers are connected to internet to make the world to be one global village everyday. The personal computers which is widely supplied these days and the world wide web (www) of multi media function which helps people to approach to the internet more easily have been greatly contributed to the bottom of such advance.

It is general that almost every cyber service on internet is presented by the internet service provider (ISP) as he proffers various merchandises, data, and service to the internet site. And the expenses for the data and services are also generally appropriated by the service users or by the advertising fees which is paid by the clients for his advertisement of merchandises and/or services on internet sites.

The World Wide Web (www) is rapidly developed by its commercial services and Electronic Commerce is the exemplary case of it. Recently, it is rapidly applied even more in banks and security corporations. It enables the various services such as geographical information, dynamic or passive banner advertisement, internet telephone, internet TV, and internet facsimile to be served on internet. What is more, it contributes to the popularization of internet and the bottom expansion of internet user population.

On the other hands, even though it is considered that inter is an unlimited sea of information, but there are also lots of unnecessary and undesirable information. Accordingly, it is true that it has a contrary function due to such bad information. And currently, there is no benefit to the information provider who serves the informations on internet. Therefore, there are also lots of negative side in sharing data which is very useful and necessary to many persons. That is, some of the low quality information can be uploaded because the information provider is not responsible for his information, and searching of useful and necessary information or data is not easy. And it causes to waste lots of time.

Generally we think that internet is a media and culture. And the popularization of super speed communication network system resulted in super speed and mass capacity of user's network environment. Also, advent of those softwares which transmit multimedia data (contents) such as documents, voice, and image in real time enables the dual direction transmission of such multi media data as voice, image, and animations, etc on the internet. Furthermore, this trend of internet development will form a new paradigm according to the increase of users' need to obtain more information in various forms.

### DISCLOSURE OF THE INVENTION

Here are the detailed illustrations of this invention by attached drawings.

<FIG. 1>

This illustrates a notional view for sharing data in this invention.

When an information (data) user requests any necessary information on the bulletin board of data sharing site, if an information provider sees it on the bulletin board and he owns such information, he connects to the data sharing site with his client system on internet network, and he uploads the requested information to the data base thru login procedure. Though there is no request of information, he can uploads any information to the data base of data sharing site by his own judgement if he thinks it is necessary useful to public.

And the personnels of human resources related to information transmission in this invention are classified into plural numbers of the information provider, plural numbers of the information user, the manager of data sharing site, and enterprises or individual hosts of advertisement.

<FIG. 2>

The information users pay the information fee to the information provider when they use the information. At this time, the information user can pay the fee judged by himself as to be reasonable for level of the information or have to pay the already charged by the information provider in advance.

<FIG. 3>

This shows that a certain portion of advertising fee from enterprises or individual banner advertisement host can be paid to the information providers instead of information users' direct payment. And this can reduce the users' expenses and enables the users to use such information more conveniently.

<FIG. 4>

Some portion of the information fee can be shared to the manager of data sharing site for the site operation. If the user judges that the information is useful to him upon searching, he pays the information fee by clicking the enterprise's banner advertisement or the payment button (or my account button). In case of a enterprises's banner advertisement, the user lets the individuals or enterprises pay the information fee to the information provider and site manager on behalf of the user himself. And in the case of direct payment from the user's account, the user must pay the information fee to the information provider and site manager respectively from his account.

<FIG. 5>

Here shows that the benefit can be shared to the poor neighbors, heart diseased children, and poor small enterprises by one or more sponsors among those human resources. All the personnel of the human resources composed by the plural numbers of the information providers, plural numbers of the information users, site managers, and enterprises or individual advertisement hosts can also be benefited evenly among all.

<FIG. 6>

This is an illustration of the main page of data sharing site displayed by the client system of the information providers and users. It is classified by fields of industry or categories.

<FIG. 7>

In the above FIG. 6, if we click one of the subordinate softwares, more minute classification relating to the software is listed.

<FIG. 8>

If we enter into one of the data bases among the listed classification, there will be various information lists posted in the data base.

In this data base, it displays the serial number, forms of information (document, program, driver file, image, moving image, upgrade file, printing file, sound file, music file, system file, etc), title of information, information provider, and other classifications such as free information, charged information, information for helping the poor neighbors, heart diseased children, small enterprises in poor economic situation, and other information for the users to fix the fee of it, etc.

And for the convenience of information users, there are page number, “home” button (to move to the site home), “help” button for the method of using the information, “page” button for turning pages, “writing” button for posting new information, “correction” button, and “read” button for users to read it again, etc.

In the above, the information provider can delete and modify his information by inputting password to use the “writing” button.

If he wants to search because it takes too much time to list up all the posted information, there are a window for search word input and “search” button for the users to write the information provider, title, and/or body sentence of the information he needs for convenient search.

Needless to say, a search engine is installed in the data sharing site.

<FIG. 9>

This illustrates the detail contents of information by clicking one (data #691) of the posted informations in the FIG. 8.

In the above data base, there are plural numbers of banner space (4) (6) (8) for which an individual or enterprise pays the advertisement fee. There are also a combo box (10) in which users can select the unit of information fee in [symbol] ˜Z,900 _{1,000}, a fee window (12) in which a fee amount for the selected information is displayed, and a fee button (14) by which the fee is paid from the user's account directly.

And there is a report button (16) by which the user can report to center of the site when he judges the information unwholesome, illegal, and anti social morals and custom. Also the site manager can delete the posted information by his own authority if he judges the information reported by the report button to be unwholesome, illegal, and anti social morals and custom so that the site can be maintained as wholesome and useful site for all users.

In the above, the information user can pay the information fee to the information provider by clicking the charged banner advertisement, the banner advertisement (6) for helping the poor neighbors, heart diseased children, and the poor small enterprises, the common banner advertisement (8), and the fee button (14) for direct payment from his own account after he directly input the fee amount in the fee window (12) or in the combo box (10) by unit of [symbol] ₁₀˜ [symbol] _{1,000}.

<FIG. 10>

At this time, the result is displayed in the guide window as “The information fee of [symbol] ₂₀ has been paid to the information provider (Mr. Hong gil-dong).” All the payment procedure is ended when finally click the confirmation button just in the side of the result window.

And in a part of the data section, there is a space for the information provider (20) in which the data serial number (691) and the provider's personal informations such as name (Mr. Hong gil-dong), his e-mail (sss@yahoo.co.kr), and his URL (www.savervision.com).

At the below of the information provider's space, there is another space for explanation of data (22) in which any guidances or explanation of the provider's information and attachment information (attached file), if any, are displayed. And the download button (24) for the attached file is shown on the right upper corner. At the bottom of this data section, there is a close button (26) to return to the data base.

The information user can request the necessary information in the bulletin board which is not shown in this invention. And the information provider can guide the contents of his information and its up-loaded location, and he can post brief explanation, manual, and various subordinate comments of the information.

If the provider's information is valuable in this invention, he can be paid an appropriate fee for the information, and the site manager also can get income in proportion of the frequency of searching the information. Accordingly, it is profitable.

That is to say, it generates income thru sharing data and banner advertisement. By activating the data sharing, benefits are shared evenly among all. And the quality of the information will be more improved and the data sharing will be much more developed as the worthless and unuseful information will be naturally selected out.

The information provider will try to post very useful and valuable information in the spirit of ownership because once he posts his information to the data base, the value of the posted information will be increased by the searched frequency.

And sharing data will be more activated because the information provider maintains the posted information with concern in the spirit of ownership as the information fee is paid to his account in proportion to the searching frequency.

<FIG. 11>

This illustrates the block composition of this invention, the system (28) for sharing data over internet. The information sharing server (30) which is the main server of the data sharing site, composes of a firewall (32) which is a security system, web server (34), data sharing site (30), and DNS server. And this composition enables the plural numbers of the information provider (36) and plural numbers of the information user (38) can connect to the Internet Service Provider (ISP) in the information sharing server (30) on internet (40) by their own client system.

There are information sharing D/B (44), contents D/B (46), advertisement D/B (48), payment D/B (50), membership D/B (52), and mail D/B (54) in the database (D/B) server (42) which is connected to the data sharing server (30).

The information sharing D/B (44) records various data related to the data sharing sites, using history of the information user, and tendency of the user's searching. The contents D/B (46) records the information related to the various contents and entertainment. The advertisement D/B (48) records individual's and/or enterprise's advertisement and additional information related thereto and the advertisement owner's site address linked to the banner advertisement. The payment D/B (50) records the result of payment and related data thereto. The membership D/B (52) records member management information. The mail D/B (54) serves e-mailing to each members. Each D/B composes of storage and inter-connected to each other for further practical use.

This storage is a kind of device to keep data or any information for a certain period and to re-use it whenever it is needed. This is an external storage which is used for a measure of keeping mass data while the internal storage (main memory unit) which is addressed by the control unit of the central processor.

The D/B server embodies the purpose of this invention by using the related database management system (RDBMS) like oracle, informix, sybase, and DB2, object-oriented database management system (OODBMS) like gemston, orion, and O2, and real time database management system (DNBS).

Information sharing server (30) is composed of overload distribution server (56) for providing traffic due to ‘the users’ excessive connections and multi-auxiliary server belonging to the overload distribution server (56). And it is connected to payment server (62) which is also connected to the bank credit card company (60) for the electronic payment by clicking the banner advertisements (4) (6) (8) or the automatic payment button (14) to pay from my back account.

All the data and information related thereto is recorded in the payment D/B (50).

This electronic payment system is composed of payment server (62), payment gateway, and customer information control system (CICS) which is a system to manage the customer information. In the payment gateway, information fee is calculated to be distributed to those the information provider, site manager, the poor neighbors, heart diseased children, and poor small enterprises respectively, then, it is input and reconfirmed. Thus, the payment method whether is credit card payment, bank account payment, or on-line payment is chosen.

In this case, if it is credit card payment, the user inputs credit card information, and if it is bank account payment, he inputs his account number. Customer information management system can process the information input from each terminal, device, and server at the same time. It is composed of database and maintenance system.

Also a billing machine is set up in the above payment server (62) for billing process which is a compound function such as calculating function and recording function.

The security is maintained and it is prevented from hacking by the Secure Electronic Transaction (SET) for safe electronic transaction process, by the layer level encryption mode like Secure Socket Layer protocol (SSL), or by the Public Key Infra (PKI) encryption mode for the merchandise transaction on internet or network system.

The Secure Electronic Transaction (SET) is a protocol to build-up credit card payment system which the VISA card and Mastercard apply as one of electronic payment systems to guarantee the safety not to be stolen any personal information such as card number or cipher.

The Secure Socket Layer protocol (SSL) is structured to have the security function (encryption, guarantee for the data, authentication) which is changeable in the network as the Netscape in USA proposes. It is characterized to set up a hierarchy for security between application and TCP/IP, and enables any application protocol to achieve more safe data exchange.

And the bank and/or credit card company pays the information fee from user's account to the information provider's account when a information user reads or downloads (including “keeping” and screen capture) any certain useful information in the data sharing site.

Once a data is used, the payment server (62) transmits the payment information to the computer terminal of the associated members of bank/credit card company (60), and receives the confirmation information of successful payment. Then, payment is finished.

And backup server (64) to provide against data loss or hacking and mail server (66) are connected to the data sharing server (30).

The web server (34) of data sharing site in this invention has the function to transmit the information of a user's need to the user's client and browser thru internet protocol, shows the information list which is uploaded in the bulletin board or database, and saves the used information data in a database after payment is finished.

Also in the data sharing server (30), there are various programs furnished, such as server web program for management to operate the data sharing site, other various program including ASP program, the information provider's up-load program, the information user's download program, and member registration program for new member's registration.

The Active Server Page (ASP) program of the data sharing server (30) manages and controls the various database on the internet web site, enables the data to be transmitted to a user's browser on internet, and implements as a language program like PHP or JSP (Java Server Page) instead of ASP program.

The entertainment provided by the contents D/B (46) can present certain information about the user's concern, for instance, movie, culture, hobby, game, and daily living information.

The information provider always keep trying to changes and/or up-grade a new data in order to respond to the user's needs more actively. For example, the service is not limited only in traveling, culture, insurance, vehicles, transportation, and accommodation, but more . . . . . The new intelligent property right and thereto related information are also shared on the internet thru the data sharing site of this invention.

The user's program managed by the data sharing site of this invention inputs the membership information of the data sharer and confirms it, and it chooses the payment method whether it is credit card payment or online payment thru bank account.

In this case, if the payment method is credit card payment, it inputs the card information, and confirms the credit card thru the above payment gateway. And it gets approved for use of the credit card. If the payment method is bank account payment or online payment, it chooses the payment bank, and keeps it in the payment D/B (50). And then, it transmits to report the result of process to the information provider, sponsor, and banner advertisement host by e-mail.

The client system of information provider (36) and information user (38) is composed of personal computer/display which receives data from data sharing site, and decides to use it or not, and transmits data using intention and payment intention related thereto according to the data sharer's operation by carrying out the data communication thru internet (40) or network.

It is also composed by web browser, operating program, communication program, computer with peripheral components, and communication devices connected to internet by cable or wireless system. The communication devices must include communication measures for internet communication, such as modem, ISDN, lan card, ADSL, HDSL, VDSL, and satellite network of communication satellite. Further, it includes operating program (O/S) to communicate with computer which has the communication network of cable and/or wireless system including mobile phone. And it also basically includes the application programs which can embody the function of communication program with web browser (or messenger) and multimedia.

Information sharing server (30) is composed by control unit like central processing unit, memory unit which saves and outputs the merchandise information according to the control of the above control unit, display unit which displays the motion of the data sharing site on the screen according to the control of the control unit, input units such as key board, mouse, CCD camera, and mike, etc to input orders to the control unit according to the manager's operation, auxiliary memory unit of the control unit, and the communication interface unit such as (super) speed communication network, router, and modem which interfaces the data in order to transmit them between information provider and the users being connected to the above control unit.

The client system of the information user (38) can be mostly or partially applied not only to computer but also to all the merchandise which is connected to internet like web box, setup box, internet TV, web phone, internet refrigerator, internet washing machine, and mobile phone.

This invention is the very site that presents a new paradigm by vesting a value of data sharing on invisible cyber space. This contributes to help the information provider, site manger, the poor neighbors, heart diseased children, and poor small enterprises with a part of the income derived from data sharing as a sponsoring measure. This invention is also distinguished in sharing the wanted data, necessary data, and high value added data not only to those of existing unspecified multiple members but also to non-membership users.

Network is jointly kept up by the information provider (36), information user (38), site manager, and advertisement host, not by the user's life style. They can share the information very stably, and can lead the digital information community as they are composed by very active members in the spirit of ownership as partners one another.

It is desirable to compose the network to be open style like internet and/or intranet for unspecified large users' easy use.

The web server (34) of the data sharing site in this invention can be diversely applied to the operating systems of Windows (SQL), Lynux, Unix, and Macintosh. It includes the application programs working on the web server (34) besides the conventional web server program.

The Information sharing D/B (44) contains every information such as up/download date of the file, related data to the file, up/download time, size of the file, and file provider, etc.

The membership D/B (52) contains those fields of members' personal information such as membership code, where to contact, e-mail address, bank references, ID, and password, etc.

And it is desirable to preserve the membership registration system for safety and convenience of payment but this system also can be operated for the nonmembership users to use, as well.

The procedures of membership registration to the data sharing site for the information provider (36) and information user (38) are as follows;

They connect to the data sharing site by using their own client system and communication network, and then there appears a screen for registration by the membership registration program. They read the agreement, and approve the contents of it. They input various informations for membership such as name, address, personal identification number, telephone number, ID, and password, etc according to the prescribed procedures. Thus, the registration is successfully finished, they can enjoy every benefit as members of the site.

After registered, the information provider (36) and information user (38) connect to the web server (34) of the data sharing site by their client system, internet, or computer communication network. After authentication procedure, they can upload any data or read the uploaded data and can download their necessary information.

In case if it is hard or troublesome to find the necessary information in the uploaded data, they can search the information provider, title of information, body sentence, file name, and data name with keyword by using the search function.

Once a user can choose some of the data, and keep them in the temporary storage allotted to members in the data sharing site. Then, he can directly download the data by his client system in real time. If he doesn't want all or a part of the data, he can delete it in the temporary storage at any time.

<FIG. 12>

This illustrates the flow of the procedures for data uploading and reading in this invention.

When a registered member of the data sharing site or a nonmembership user connects to the data sharing site by their client system and internet communication network (S1 step), the member (S2 step) inputs his ID and password, and clicks login (S6 step). After authenticated his membership, he can use the data in the site. At this time, he must decide his work whether he uploads any data or reads any of the registered data (S7 step).

In case of nonmembership user, he reads the agreement in the registration section and fully approves the contents of the agreement (S4 step). He inputs all the necessary information for membership, and receives ID and password after authenticated (S5 step), then clicks the registration button to finalize the registration procedures. Again he must login (S6 step), and choose his work (S7 step). Sometimes, those non-membership users can use free data in the data sharing site without any procedure of authentication.

The information provider can upload any data to the data base of the sharing site (S12 step) or delete his upload data (S11 step), or practice other works (S14 step).

The information user (38) can visit the database of the data sharing site and read the data as he wants (S13 step). For any hard information to find, he can search the data (S10 step) and practice other works (S14 step) as well.

If any of the information provider (36) or information user (38) gives up data upload or use, or already completed uploading and/or reading, they logout (S8 step), and finish all the works (S9 step).

Information user (36) can use any data if he judges it wanted, necessary, or useful (S15 step). If there is no useful data, he turns back to the work selecting step (S7 step), and he can repeat the procedures again for other data.

If any data is necessary and useful to him, he pays for the information (S16 step). If he doesn't pay for the information at this time, he must return to the work selecting procedure (S7 step) for another work, or he must finish his works (S9 step) thru the logout (S8 step). If he wants to pay for the information (S16 step), he selects the payment amount (S17 step), and selects the payment method.

That is, he selects the banner advertisement payment method or his bank account payment method (S18 step). In this case, if he selects the banner advertisement payment method for which an individual or enterprise sponsors, he just clicks the window of the banner advertisement.

Then, half of the payment amount selected in S17 step is allotted to the information provider's account of the data sharing site (S20 step), and the rest half or some portion of the payment amount will be paid to the manager of data sharing site who works for the brokery role for data sharing (S22 step).

If the payment amount exceeds the payable amount with the banner advertisement fee, or if an information user pays from his own account by his judgement (S19 step), again the half of the payment amount for the used information will be paid to the information provider from his account (Sl9 step) and the other half or some portion of the payment amount will be paid to the manager of data sharing site for his brokery role (S22 step).

The information provider and manager of the data sharing site can allot a part or all of the advertisement fee paid by the information user to the poor neighbors, heart diseased children, and the poor small enterprises, respectively (S21 step).

<FIG. 13>

This illustrates the procedure of information provider's data uploading in this invention.

The information provider (36) himself fixes the value of the uploading information (S23 step), and he himself decides the usage of the income for the provided information (S24 step).

The information provider classifies, free information for any information users (S25 step), charged information for his own income (S26 step), charged information for the poor neighbor and heart diseased children (S27 step), charged information for poor small enterprises (S28 step), and other charged information for which information users can decide the usage, etc. Those classified informations are displayed on the information section. Then, the information provider inputs other data (S30 step), and he can finish (S32 step) his works by clicking the data upload button (S31 step).

The sponsoring amount to the poor neighbors, heart is diseased children, and poor small enterprises are clearly allotted to each of them by notice of e-mail system.

For searching procedure, all the data of the uploaded information such as data name, data size, kind of data, images related to the data, character of data, value of data, information provider's name, and index key words will be usefully referred as the basic information of the data.

Also, the data is classified by its category and uploading date because some information providers upload plural numbers of data. Also, plural numbers of data can be registered by some providers as they upgrade the data, therefore it can be further classified by the specification of data.

Data selection step is the procedure in which a certain data is chosen among searched data by the information user as he wants and needs it, and the selected data is practically used by the user. In case of the above selected data is a file or program, the images and further explanation related thereto are served in form of attachment.

In the data using step, the intention to use the data chosen in the above data selection step is delivered to web server (34), and the data is served to the information user (36). And the data served in the data using step are mainly user's name, user's ID, data name and its speciality, contacts including e-mail, payment method, and contents of the payment, Also the user's data using intention is confirmed by selecting the using menu among the data chosen in the data selection step.

Payment step is the step to pay the information fee (amount) to the information provider (36), site manager, and those who are supported by the fee. Payment is mainly practiced by banner advertisement transaction, my account transaction, electronic money, and the cyber money or cyber point which is accumulated by other sites.

Currently such payment method or technology are widely used or being developed, so further explanation is not necessary here.

The firewall (32) is located between the external network like internet and internal network of the data sharing site, and senses any invasion from external network to internal network to protect various data and resources.

This invention is so far precisely explained by the drawings and illustrations but it's not all. It can be substituted, modified, and changed in the technical notion of this invention.

As explained above, this invention is to share various data (such as various digitalized files or information, data, multi media file, etc) on the internet. This invention presents the earning model to allot a certain amount of price to the information provider so that the information provider can serve more developed and high quality information to information users. It will surely contribute greatly to the activation of data sharing.

In this invention, the information provider shall serve the data more actively and considerably because the information users pay the information fee if they judge the data is useful and profitable after they read the provider's data. Less valuable and unnecessary data will not be read by the users and will be naturally selected out.

The information users can pay reasonable information fee with their bank account, cyber money, or electronic money when they judge them useful, but banner advertisement fee from an individual or enterprise is also allotted instead of the above payment measures. This results in reduction of the information users' charge and in double effects of the advertisement.

This invention can keep maintaining the operation of data sharing site by paying some portion of the information fee to the site manager. This invention also raises up the good image of the data sharing site by distributing some portion of the information fee to the poor neighbors, heart diseased children, and poor small enterprises.

This invention can also operate the data sharing site so favorably because the site manager can delete such bad data as unwholesome, illegal, and anti good social morals and customs with his authority upon users' report by clicking the report button to prevent from its evil influence.

The site manager only operates and maintains the site by inducing advertisements and by extension of system installation for anti-traffic. He is hardly restricted not to interfere and affect to the uploaded data, and so, he can't be the obstacle elements to the data sharing.

In this invention, the information provider can directly fix the value of information which he uploads, and can decide the usage of the data. This affects in fixing the usage of data as free information, charged information for the provider's income, sponsoring data to help the poor neighbors, heart diseased children, poor small enterprises, and other data for which the user can fix the information fee, etc.

The banner advertisement fee can be allotted to the poor neighborhoods, heart diseased children, and poor small enterprises. In this case, the contents of expenditure will be reported to the sponsors and personnels concerned thereto by e-mailing to raise up the clearness of the site operation. This results in the rewarding some portion of income to the society. This helps the public relationship of the data sharing site to be raised up the total image of the site. And this invention deserves to its function as a mass transmission media of useful data.

### Brief Description of the Drawings

FIG. 1: conceptional diagram of data sharing in this invention.

FIG. 2: conceptional diagram of the payment method of information fee by data sharing in this invention.

FIG. 3: conceptional diagram of the pavment method of information fee from banner advertisement fee in this invention.

FIG. 4: conceptional diagram of the allotment of information in this invention.

FIG. 5: diagram of public using of the sharing data and payment method of the information fee in this invention.

FIG. 6: diagram of the main page of an illustration in this invention.

FIG. 7: diagram of the subordinated page of an illustration in this invention.

FIG. 8: diagram of an illustration of data base in this invention.

FIG. 9: diagram of an illustration of data section in this invention.

FIG. 10: guiding diagram of payment result in this invention.

FIG. 11: block composition diagram of an illustration of the data sharing system in this invention.

FIG. 12: total flow diagram of an illustration in this invention.

FIG. 13: flow diagram of data upload of an illustration in this invention.

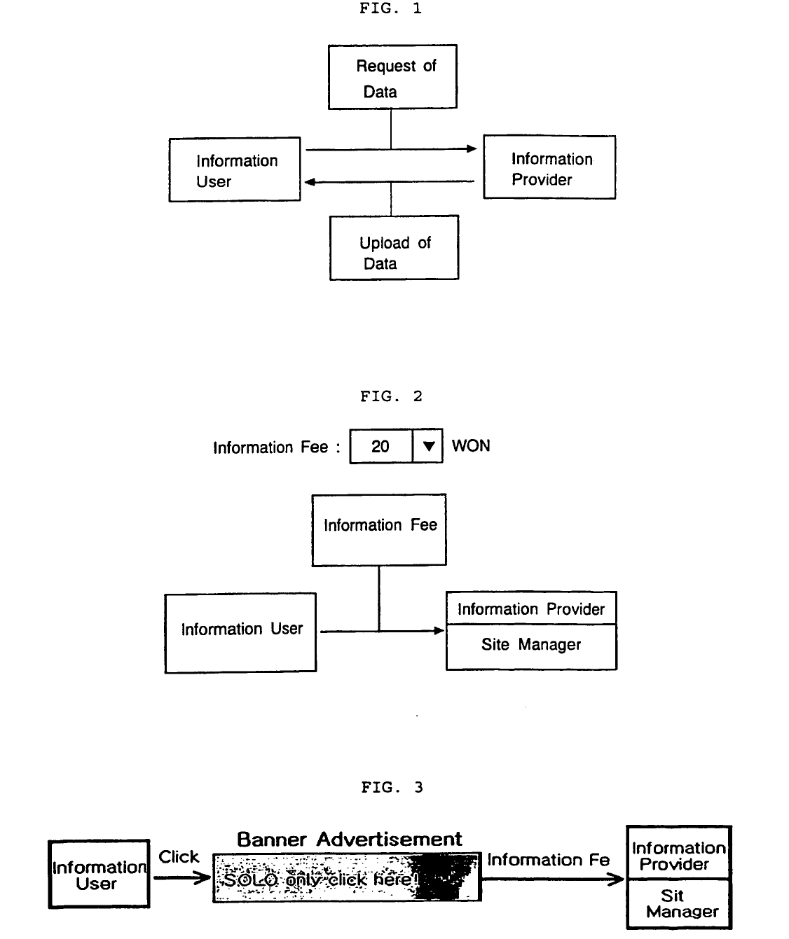

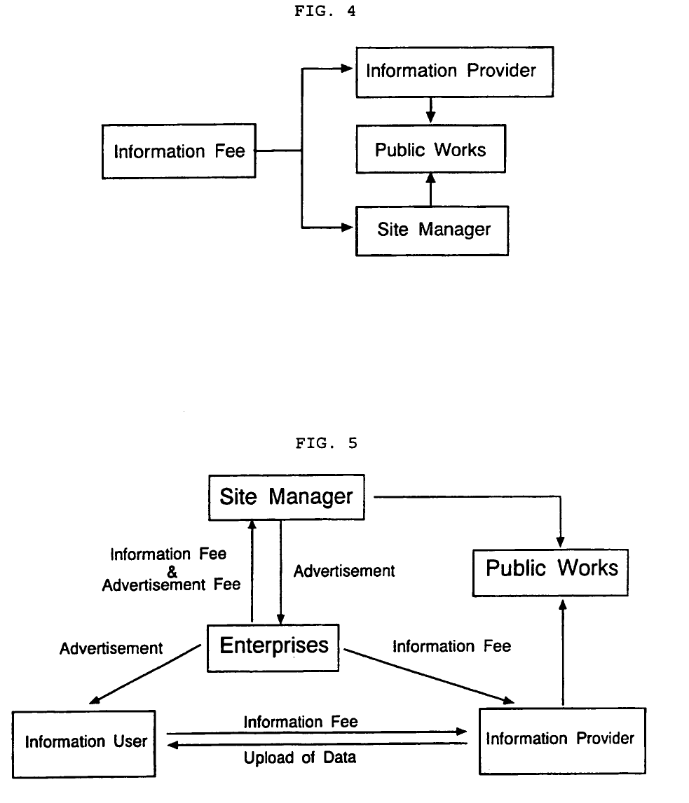

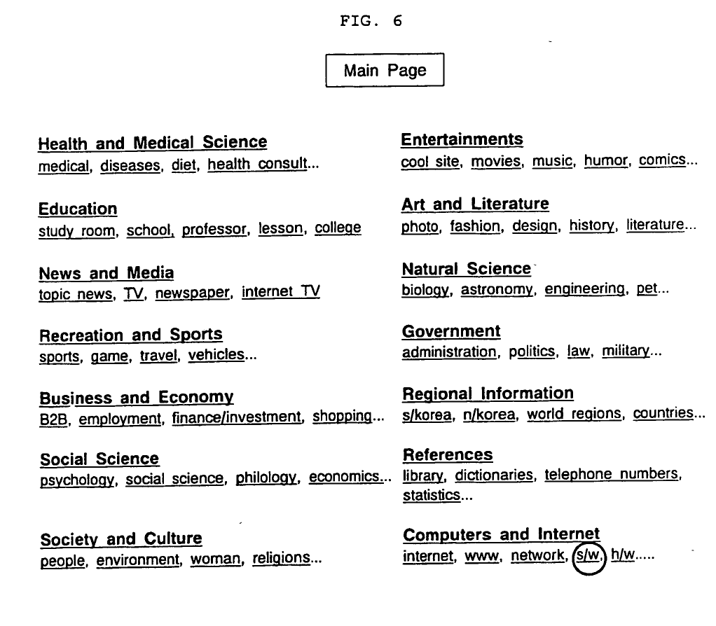

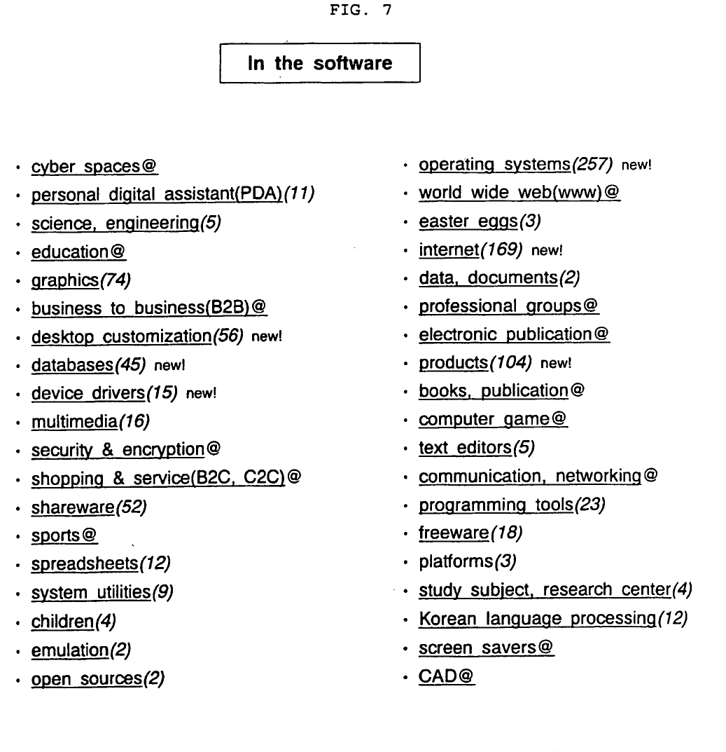

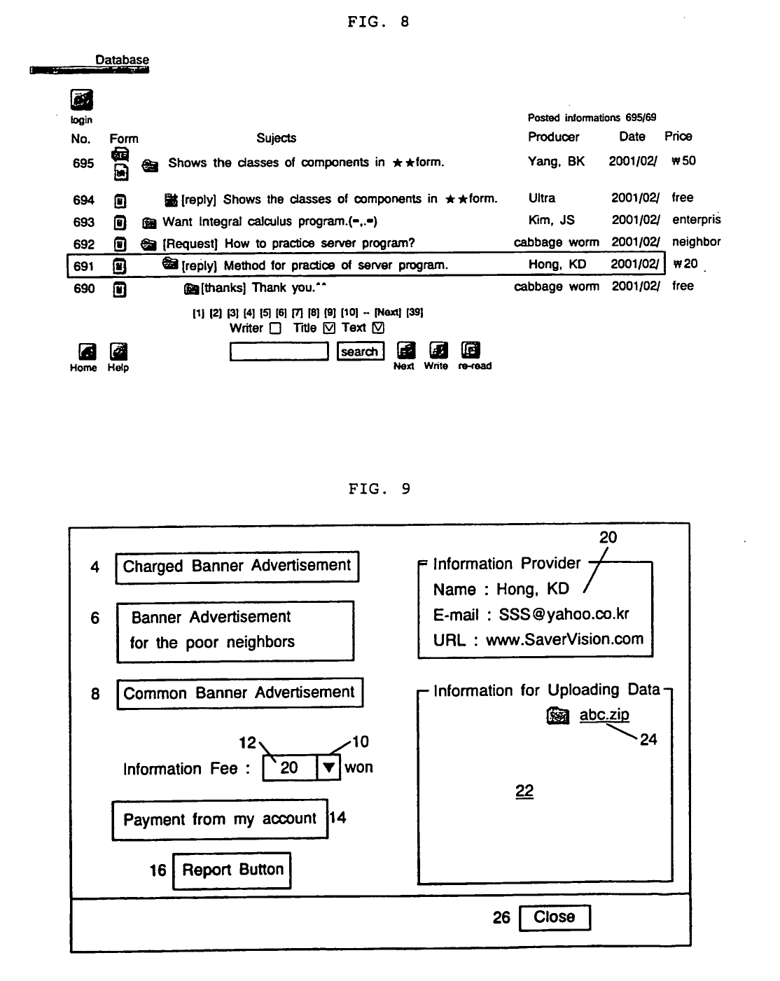

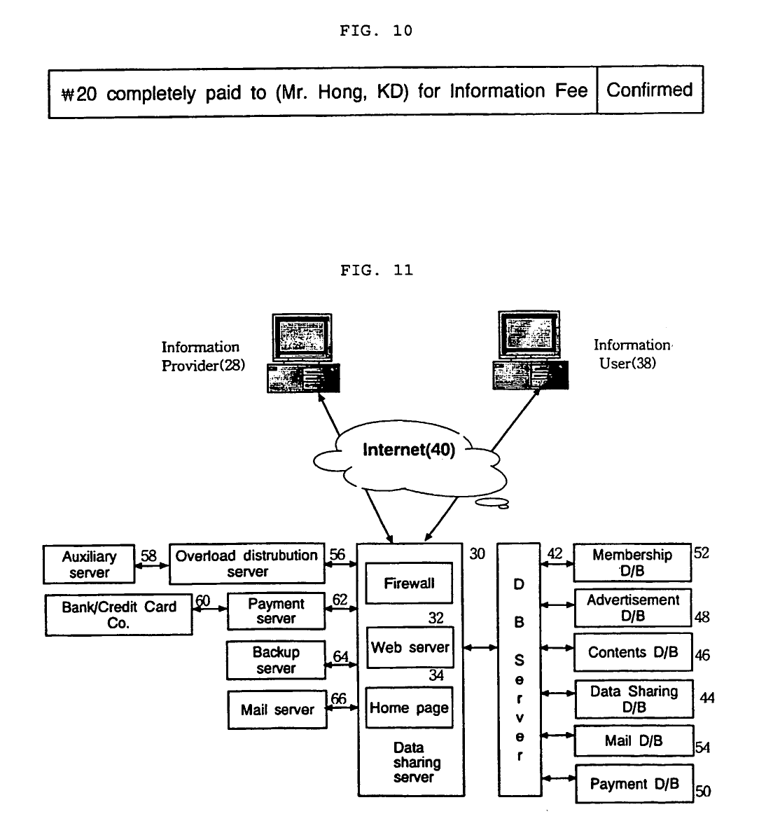

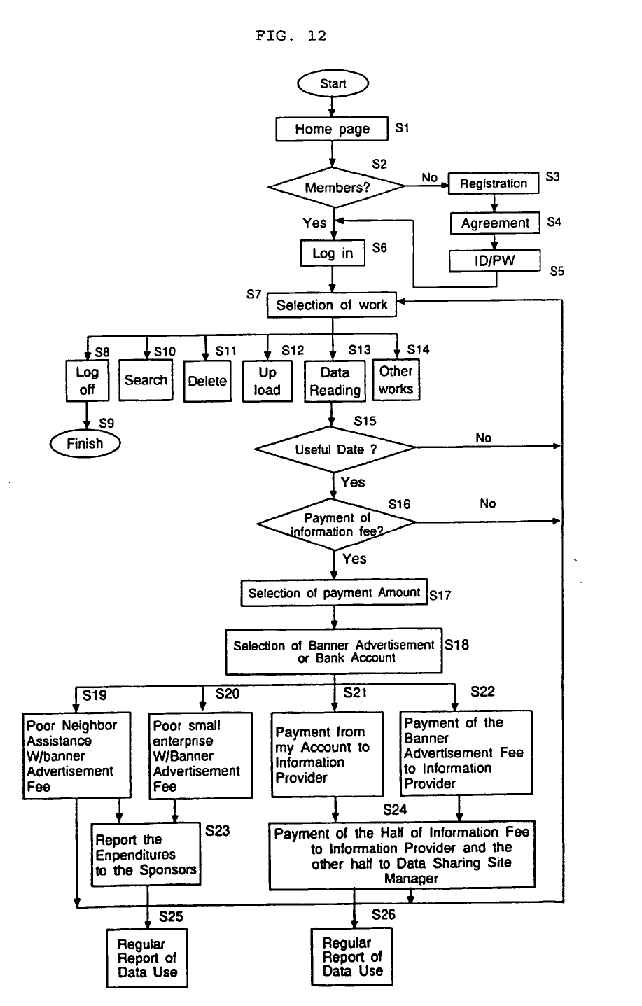

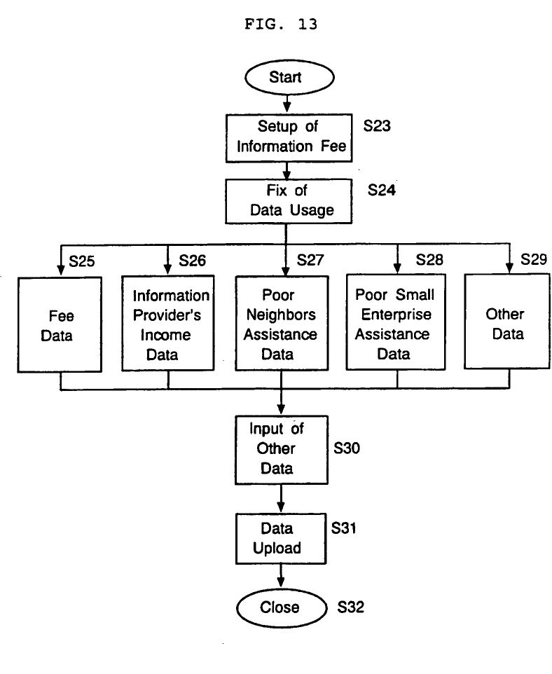

### TITLES OF THE IMPORTANT PARTS IN DRAWINGS

(4) (6) (8)—banner advertisement section

(10)—combo box

(12)—display window of information fee

(14)—payment button of information fee

(16)—report button

(20)—section of information provider

(22)—section of explanation for data

(24)—section of download

(26)—close button

(28)—data sharing system

(30)—data sharing server

(32)—firewall

(34)—web server

(36)—information provider

(38)—information user

(40)—internet

(42)—data base server

(44)—data sharing D/B

(46)—contents D/B

(48)—advertisement D/B

(50)—payment D/B

(52)—membership D/B

(54)—mail D/B

(56)—overload distribution server

(58)—auxiliary server

(60)—bank credit card company

(62)—payment server

(64)—backup server

(66)—mail server

### BEST MODE FOR CARRYING OUT THE INVENTION

Share various digitalized files or information, data, and multimedia file is practicable in this invention. And it presents an income model. It is possible in this invention to activate the data opening and data sharing because the information provider serves high quality and more advanced data on internet by paying a certain amount of price for serving information to the information provider. This also greatly contributes to data sharing.

When the information provider uploads multimedia data or files on bulletin board or data section, information users can read or search them. And if the information user judges it useful, he pays a certain amount of price for using data from his own bank account or banner advertisement fee.

The data to be shared in this invention includes at least one of all multimedia data covering the text information, sound information, voice information, data information, portrait information (images, drawings, and graphic), video music information, music information, and moving images (such moving images as movies, lecture, and study, etc.), or file pattern data or application program. It also includes electronic novel, lecture data, thesis, music file, voice file, lecture file, documents file, travel file, employment file, price information of goods, and event data, etc.

Accordingly, in this invention, when someone serves (or open) his data (and transferred data) to others, he serves more advanced data in quality to unspecified multiple users, and let the information users to pay a certain amount of price for the information to the information provider, and so they contribute to the activation of data sharing.

And in this invention, the user pays the information fee to the information provider when he judges it useful after he reads the data uploaded by the information provider. This makes the information providers to more seriously upload the data.

And the worthless and unnecessary data of no value for sharing will be turned over the reader's eyes to be naturally selected out. So it can reduce circulation or distribution of such harmful data on internet. Both the provider and user commonly become watchmen for the data to make it more qualified to be shared.

The manager of data sharing site also contributes to the activation of data sharing by presenting data sharing space, and helps the information users, banner advertisement hosts, and site manager himself by inducing banner advertisements.

That is, a information user judges value of the data he searched and fixes the amount of the information, and pays from his bank account or with cyber money. But, this invention reduces the information users' charge by paying with the banner advertisement fee which an individual or enterprise donates instead of his account.

By doing this, the provider serves more advanced data in quality continuously, and thus, data sharing is more actively activated. The host of advertisement is a sponsor to the information users and information provider. He can also propagandize his company or himself.

And by letting some portion of the information fee to be paid to the site manager, he can keep maintaining the data sharing site continuously and so favorably. And the image of the data sharing site is raised up by allotting some portion of the information fee to the poor neighbors, heart diseased children, and poor small enterprises.

In all, every related personals such as information provider, information user, data sharing site manager, and advertisement hosts are all benefited and the effect of data sharing and advertisement are elevated. This invention can serve more qualified data to those who need it by giving the value to the data on internet as mentioned above.

In this invention, more qualified data is uploaded and data sharing is actively activated, and also, low quality data is naturally selected out because the information user himself appraises the value of the data.

Bulletin board type is desirable for this invention so that the information users can see it simply and clearly at a looking at. This invention prevents data sharing site from such worthless, illegal, anti good social morals and customs by letting the site manager to delete such data. For the case of that, in this invention, there will be no speed in data sharing, needs more manpower and time, and brings about the information providers' veto, there is report button in each data section so that any user who finds such worthless data, illegal data, and data of anti good social morals and customs can click it to be reported to the site manager. Then, those data will be immediately deleted to prevent the site from circulation or distribution of such worthless and illegal data.

Also the site manager presents the data sharing space to the information provider, information user, and banner advertisement hosts. He contributes to activate data sharing, and he can help the information users and banner advertisement hosts by inducing the banner advertisement.

He also does the least role of operation and maintenance such as system increase for traffic prevention as well as the advertisement inducement. He is strictly restricted not to interfere or not to affect to data uploading.

However, he can operate and maintain the data sharing site by having the right to judge the data if they are unwholesome or illegal when so reported by users, and to delete them if judged to be so. Those unwholesome and illegal data covers all the harmful data to the youth even though it is wholesome but illegal.

The character of this invention is that the information provider himself can fix the information fee for the data he serves. He himself can fix the appropriate usage as well as the value of the data. This usage is classified into free data which the user can use it free of charge, charged data which the information provider gets it his income, the poor neighbor helping data, heart diseased children helping data, poor small enterprises helping data, and others.

And by inputting the password and other further information, the data is registered to the data sharing site. If the registration is successfully confirmed, it is finished. If wants to modify or delete the data, it can be practiced by password only, but if it is unwholesome or illegal data, the site manager can delete it by his authority.

And the banner advertisement fee can be allotted to the poor neighbors, heart diseased children, and poor small enterprises. In this case, the contents of expenditure is noticed (reported) to those of advertisement sponsors and those who are concerned to it by e-mail in order to clearly manage the information fees or operation of the site. Those contents are also noticed to the information provider and banner advertisement hosts for the same purposes.

By this procedure, it is considered to be returned to the society back, and this site is more effectively propagandized and proceeded. The image of the data sharing site is much more elevated, and it is resulted in double propaganda effectiveness, and thus, it functions its role as a useful data transmission media.

### INDUSTRIAL APPLICABILITY

This invention contributes to sharing of quality data and its activation by presenting further qualified data when a information provider opens various materials including data and dated files to unspecified multiple personnels on internet, and by paying a certain amount of price for data sharing to the information provider through the data sharing system based on internet. This invention. also enables the site manager keep maintaining the site by paying some portion of the information fee to him.

This invention lets the information provider himself to decide the information fee for the data he serves. He himself can fix the appropriate usage as well as the value of the data. This usage is classified into free data which the user can use it free of charge, charged data which the information provider gets it as his income, the poor neighbor helping data, heart diseased children helping data, poor small enterprises helping data, and others.

In this case, the contents of expenditure is noticed (reported) to those of advertisement sponsors and those who are concerned thereto by e-mail in order to clearly manage the information fee or operation of the site. Those contents are also noticed to the information provider and banner advertisement hosts for the same purposes.

By this procedure, it is considered to be returned to the society back, and this site is more effectively propagandized and proceeded. And the image of the data sharing site is much more elevated, and it is resulted in double propaganda effectiveness, and thus, it functions its role as a useful data transmission media.

What is claimed is:

1. The method for sharing data over internet which is characterized to activate sharing of quality data by steps of;
login from the client/server network environment system based on network processor to web environment system, registration of the data in the information provider's client system to the data section of the data sharing site,
selection of the usages, such as free/charged, sponsoring, and other usage of the upload data when the information provider serves the data to the data sharing site by the data sharing method based on the network to pay the information fee for the data which the users use in the data base of data sharing site in his client system, registration of data after input of other information, selection of banner advertisement or bank account in the step of payment,
and payment of some portion of the selected payment amount to the information provider and the rest to the site manager.

2. The system for sharing data over internet which is characterized that plural banner advertisement Sections (4) (6) (8) in the data section of the data sharing site, combo box (10) in which the information user can select the information fee, and its display window (12) are located in the data sharing system based on the network server having a data sharing site and which composes of; the payment button (14) to pay from the information user's account,
report button (16) to report unwholesome data, illegal data, and data of anti good social morals and customs after search,
information provider's section (20) in which there are the information provider's personal information is displayed, explanation section (20) of the upload data,
download section (24) to click/down the attached data, and close button (26) to move to the data base.

3. The method of sharing data over internet characterized to select the payment method from banner advertisement fee and/or bank account to the poor neighbors or the poor small enterprises and to notice the detailed contents and result of the expenditure to the sponsors and concerned personnels related thereto by email, in the above claim 1.

4. The system of sharing data over internet composed of,
data sharing D/B (44) in which related information to the data sharing site, such sharing data, history of used data by the information user, and the data in using tendency are recorded in the data base (D/B) server (42) connected to the data sharing server (30),
contents D/B (46) in which contents and various information about entertainment are recorded,
advertisement D/B (48) in which advertisement related data and site address of the advertisement host linking to the banner advertisement are recorded,
payment D/B (50) in which various payment information for using data is recorded,
membership D/B (52) in which membership management data is recorded,
mail D/B (54) serving e-mails to each members, in the in the data sharing system over internet which is also composed of,
data sharing server (30) combined by the firewall (32), web server (34), data sharing site (30),
and DNS server,
client system in which the plural information providers (36) and the plural information users (38) can connect to the above data sharing server (30) thru internet (40),
data base (D/B) server (42) in which various data is recorded,
overcharge distribution server (56) for traffic, payment server (62) of the bank credit card company's (60) electronic payment by clicking the payment button (14) to pay from the banner advertisements (4)(6)(8) or my account, backup server (64) for the loss of data or hacking, and mail server (66) for mailing exchanges.

5. The data sharing system characterized that the information user's client system is at least one of those of web box having communication measures, setup box, internet TV, web phone, internet refrigerator, and internet washing machine in the above claim 4.
